(19) United States
(12) Patent Application Publication
(10) Pub. No.: US 2010/0317229 A1
(43) Pub. Date: Dec. 16, 2010

(54) Electrical Connector

(76) Inventors: Cheng Wen Chen, Taipei (TW); Yi Wei Chang, Taipei (TW); Sheng Wen Peng, Taipei (TW)

Correspondence Address: BARLEY SNYDER, LLC, 1000 WESTLAKES DRIVE, SUITE 275, BERWYN, PA, 19312, US

(21) Appl. No.: 12/815,692

(22) Filed: Jun. 15, 2010

(30) Foreign Application Priority Data
Jun. 16, 2009 (TW) 98120120

(51) Int. Cl. H01R 13/648

(52) U.S. Cl. 439/607.23

(57) ABSTRACT

A socket connector having a plurality of connectors, and at least one corresponding plug connector inserts into the socket connector. The socket connector includes a shielding housing having a plurality of sidewalls that define at least one receiving slot, and a body provided with the plurality of connectors and a plurality of conductive contacts assembled to each of the plurality of connectors. The plurality of connectors are different types of I/O connectors arranged in a side-by-side manner. The shielding housing encloses a plurality of walls of the body so that the plurality of connectors are located within the at least one receiving slot. The plug connector includes a plurality of contact receptacles, which correspond to the plurality of different types of connectors, which are arranged in a side-by-side manner.

### CROSS-REFERENCE TO RELATED APPLICATIONS

This application claims priority under 35 U.S.C. §119 to Taiwanese Patent Application No. 98120120, filed Jun. 16, 2009.

1. Field of the Invention

The present invention relates to an electrical connector, and more particularly, to a socket connector which includes at least two different types of input/output (I/O) connectors positioned side-by side.

2. Background

As technology advances, various types of electronic products are being developed to meet consumer needs. For those products to achieve high performance, it is essential to maintain stability within electronic components. The stability standard for electronic components is constantly rising to cope with higher performance requirements, as well as the diverse environment in which these components perform.

Connectors serve as mediums, connecting and transporting signals between different electronic products. Hence, the stability of connectors plays a key role in the performance of electronic products; moreover, how to make the assembly and maintenance of connectors easier is also an important issue.

Taiwan Patent Publication No. M261902 discloses a card connector having a housing and a shielding portion, the housing and the shielding portion combine to define a receiving space. The receiving space is provided with a central wall which divides the receiving space into a first receiving space and a second receiving space. A plurality of first contacts are assembled onto the shielding portion within the first receiving space, and a plurality of second contacts are assembled onto the shielding portion within the second receiving space. The first and second contacts are for contacting with different types of card connectors.

D-sub (D-subminiature) connectors are a common type of I/O connector. And recently, with rapid developments in computer and information technologies, electronic devices with high-speed data transmission capabilities have become mainstream in the consumer electronics market. Accordingly, interface types for high-speed data transmission, such as the earlier USB, eSATA and the recent DisplayPort, HDMI (High Definition Multimedia Interface), have become commonly adopted components in an electronic device. Until now on the market, however, there has not existed a product that combines both a D-sub connector and a high-speed data transmission connector arranged side-by-side. Thus, there remains a need to develop such a product.

### SUMMARY

An objective of the present invention is to provide a socket connector having a plurality of connectors, and at least one corresponding plug connector inserts into the socket connector. Since the socket connector is configured with two types of I/O connectors, a user is allowed to choose one of the two types or use both types at the same time. Compared with a conventional one, a socket connector of the present invention thus saves more space and is more convenient to use.

The socket connector includes a shielding housing having a plurality of sidewalls and defining a receiving slot, and a body provided with a plurality of connectors. The body assembles with the shielding housing so that the plurality of connectors are positioned within the receiving slot.

### BRIEF DESCRIPTION OF THE DRAWINGS

The invention will be explained in greater detail below with reference to Figures and exemplary embodiments, without the general concept of the invention being limited.

FIG. 1A is an exploded view of a socket connector according to the invention;

FIGS. 1B and 1C are assembly drawings of the socket connector shown in FIG. 1;

FIG. 1D is a front view of the socket connector shown in FIG. 1;

FIGS. 2A and 2B are perspective views of a plug connector according to the present invention;

FIG. 3A is an exploded assembly drawing of the socket connector and the plug connector according to the invention;

FIG. 3B is an assembly drawing of the socket connector and the plug connector according to the invention;

FIG. 4A is an exploded view of a socket connector according another embodiment of the invention;

FIGS. 4B and 4C are assembly drawings of the socket connector of FIG. 4A;

FIG. 4D is a front view of the socket connector shown in FIG. 4A;

FIG. 5A is an exploded assembly drawing of the plug connector and the socket connector according to another embodiment of the invention; and

FIG. 5B is an assembly drawing of the plug connector and the socket connector according to another embodiment of the invention.

### DETAILED DESCRIPTION OF THE EMBODIMENT(S)

The present invention now will be described more fully hereinafter with reference to the accompanying drawings, in which embodiments of the invention are shown. It is to be understood that although the following description mainly provides socket connectors having a D-sub connector and an HDMI connector as examples, all kinds of alterations and changes can be made by those skilled in the art, without deviating from the spirit and the scope of the invention. This description is not to be taken in a limiting sense, but is made merely for the purpose of illustrating the general principles of the invention.

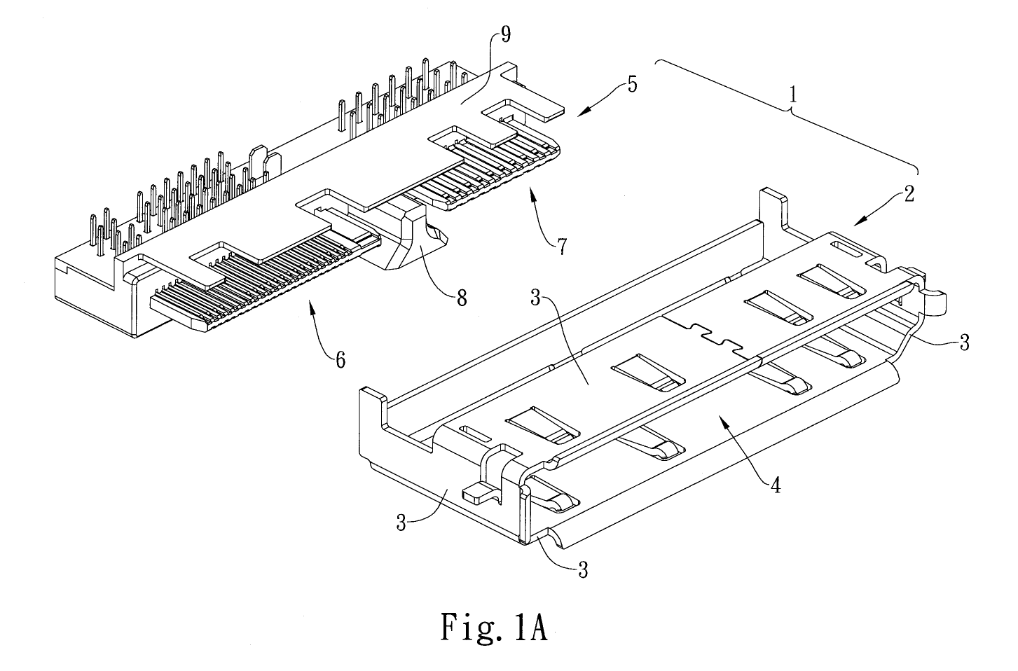

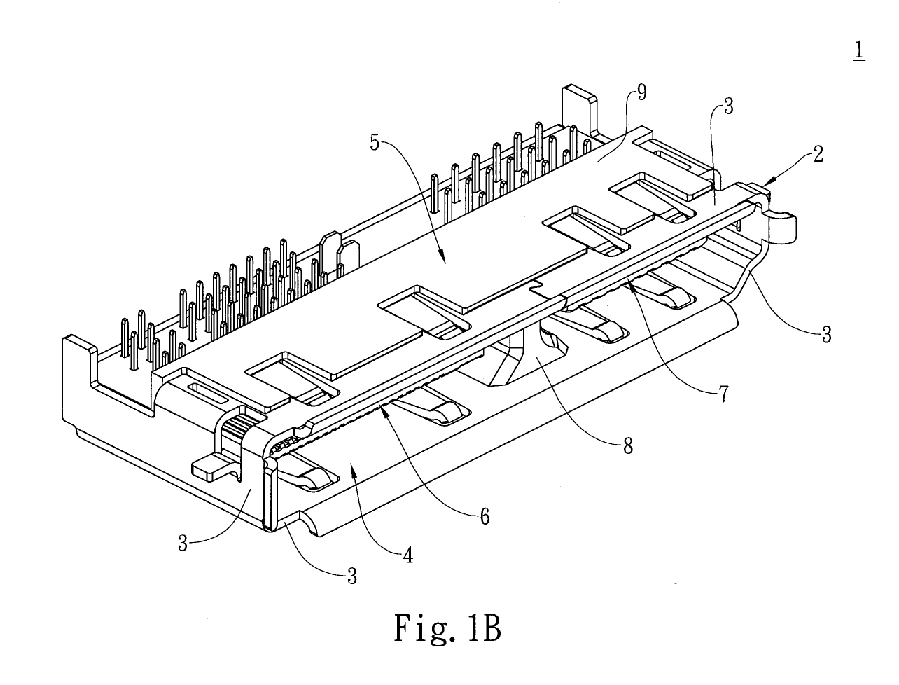

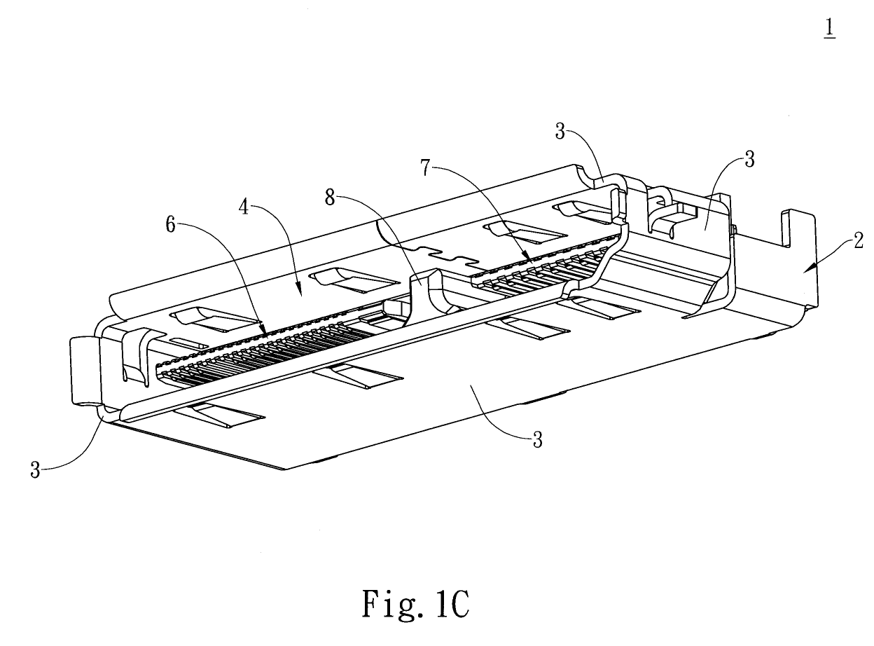

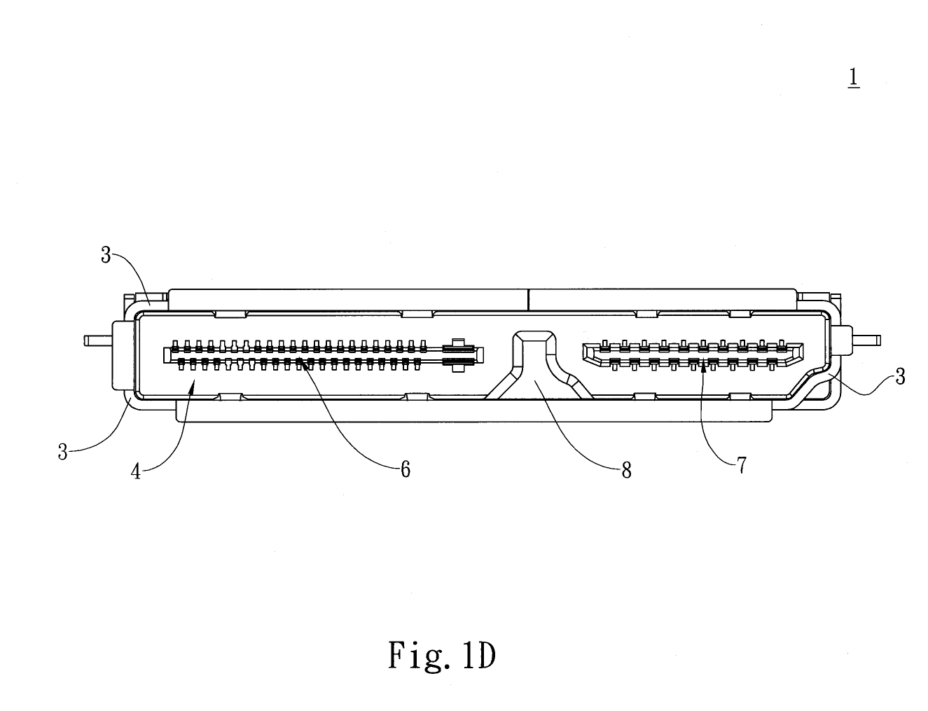

Referring to FIGS. 1A, 1B, 1C and 1D, a socket connector 1 according to the invention is shown having a shielding housing 2, a receiving slot 4, and a body 5. The shielding housing 2 includes a plurality of sidewalls 3 that define the receiving slot 4. The body 5 is provided with two types of I/O connectors—a first connector 6 and a second connector 7. The body 5 is assembled to the shielding housing 2 so that the first connector 6 and the second connector 7 are located within the receiving slot 4. The body 5 is also provided with a support 9 in order to protect the shielding housing 2 from being deformed by an excess external force.

In embodiment shown, the first connector 6 is a D-sub connector, the second connector 7 is an HDMI connector. The first connector 6 and the second connector 7 are arranged in a side-by-side manner. Moreover, the body 5 is further includes with a guide 8 between the D-sub connector 6 and the HDMI connector 7. The guide 8 has a horizontal top edge and asymmetrical left and right edges.

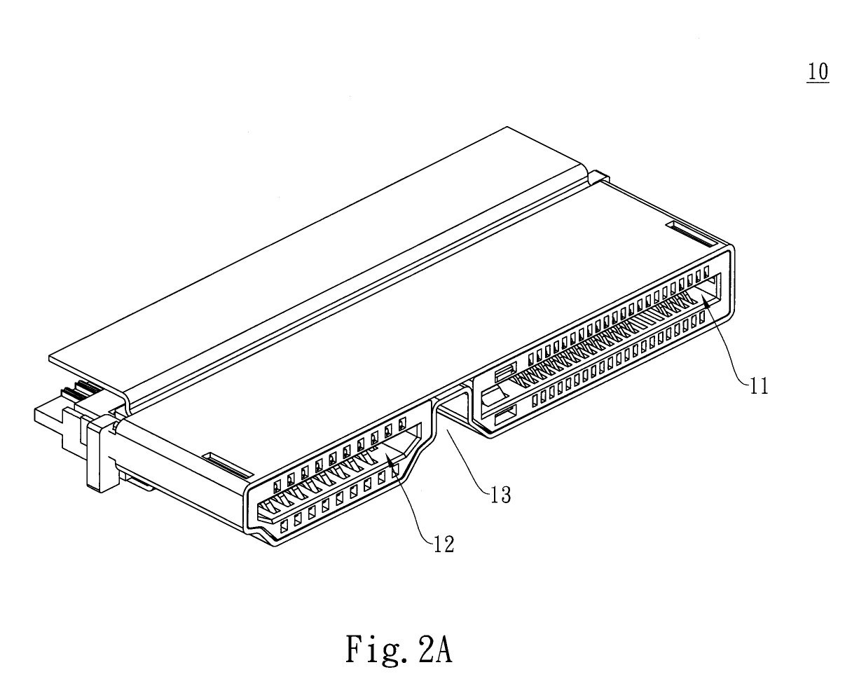

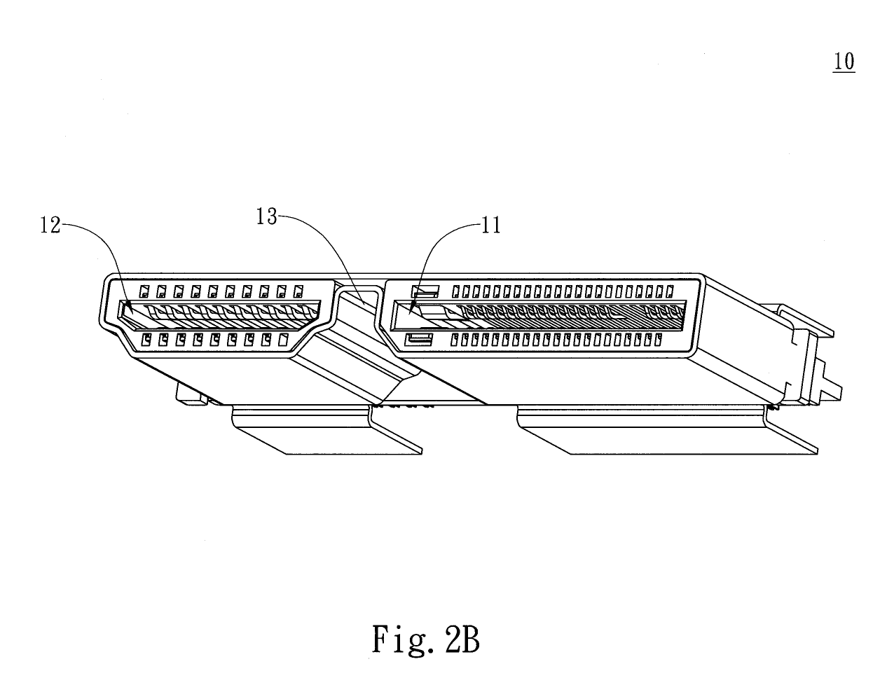

FIGS. 2A and 2B show a plug connector 10 having a D-sub contact receptacle 11 and an HDMI contact receptacle 12. A retaining portion 13 is formed between the D-sub contact receptacle 11 and the HDMI contact receptacle 12.

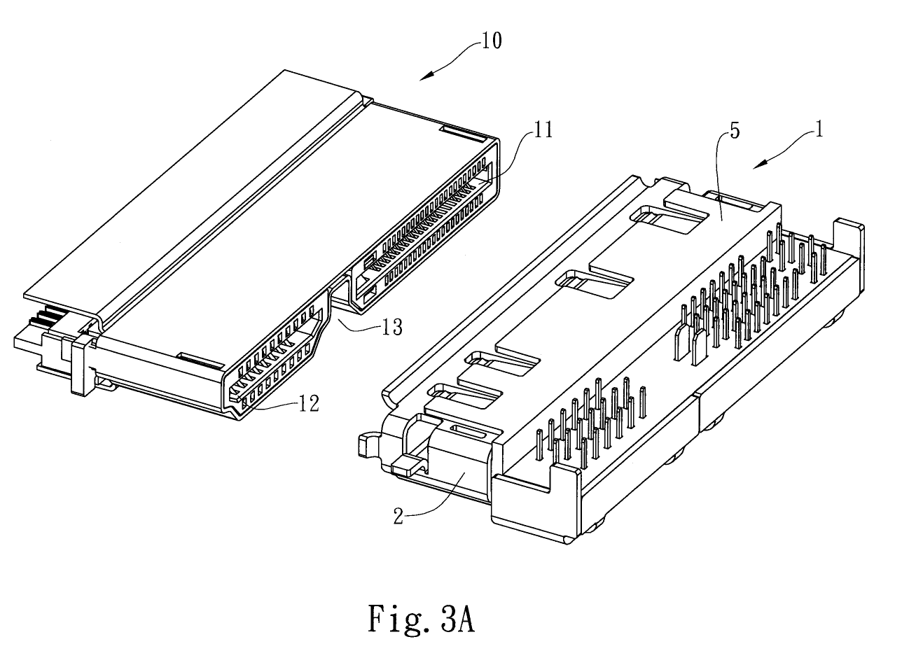

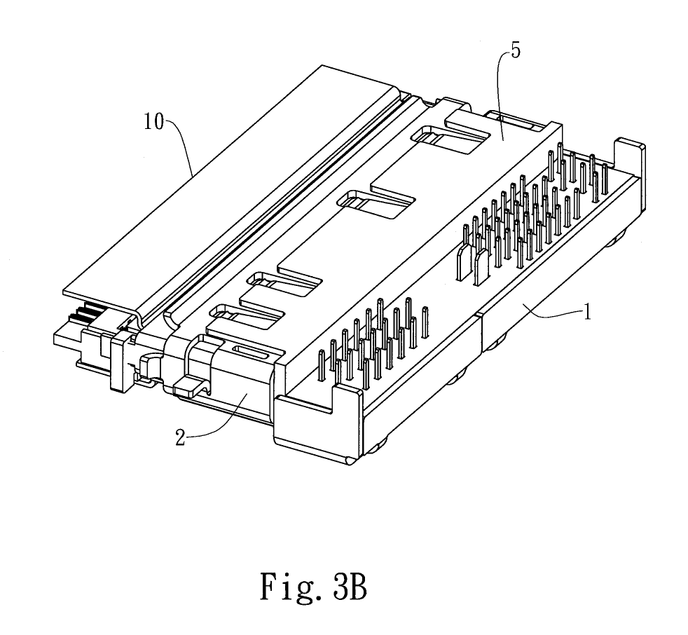

Referring to FIGS. 3A and 3B, the plug connector 10 and the socket connector 1 according to the present invention are shown in an assembling and assembled state. In the embodiment shown, the D-sub contact receptacle 11 and the HDMI contact receptacle 12 of the plug connector 10 correspond to the D-sub connector 6 and the HDMI connector 7 of the socket connector 1 respectively.

When the plug connector 10 is being inserted into the receiving slot 4 of the socket connector 1, the guide 8 can direct the plug connector 10 to be smoothly inserted into the socket connector 1, so that the D-sub contact receptacle 11 can mate with the D-sub connector 6, the HDMI contact receptacle 12 can connect with the HDMI connector 7, and the guide 8 can be retained in the retaining portion 13.

The guide 8 of the socket connector 1 is an anti-mismating design, which helps to prevent the plug connector 10 from being inserted into the socket connector 1 upside down. Moreover, the directing function of the guide 8 can facilitate a smoother connection between the plug connector 10 and the socket connector 1.

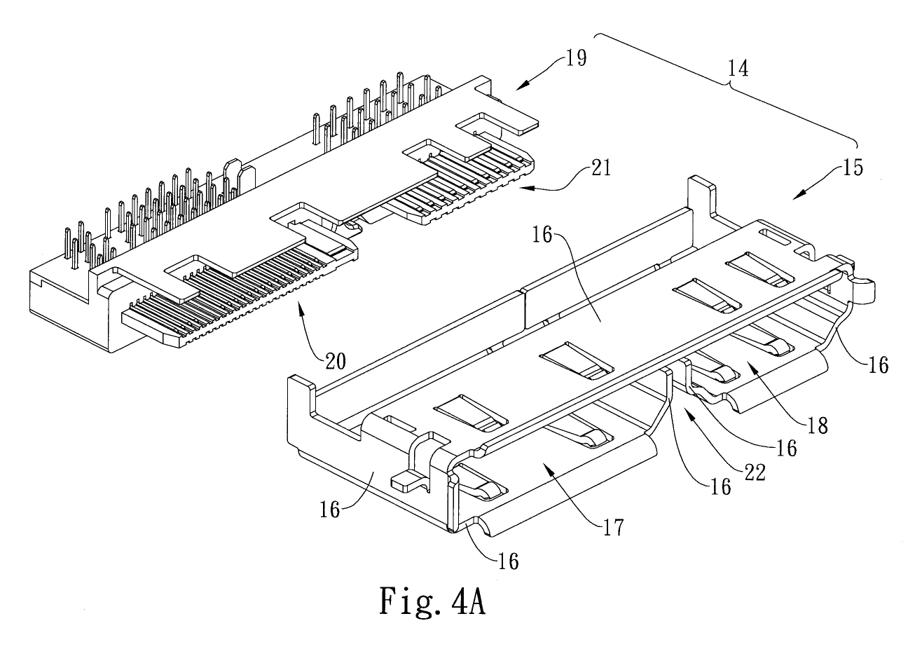

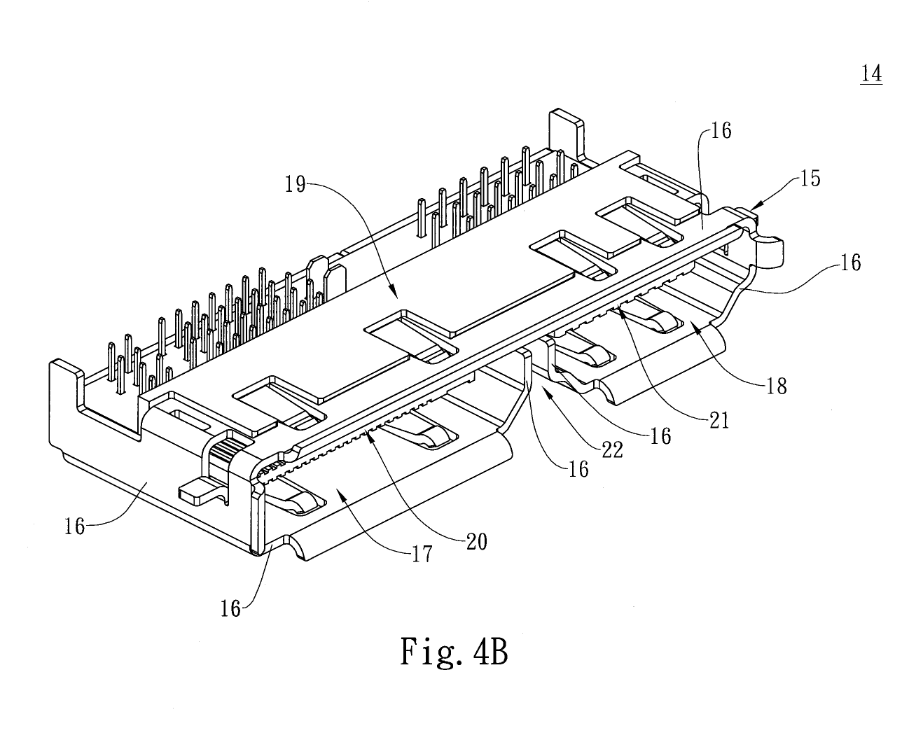

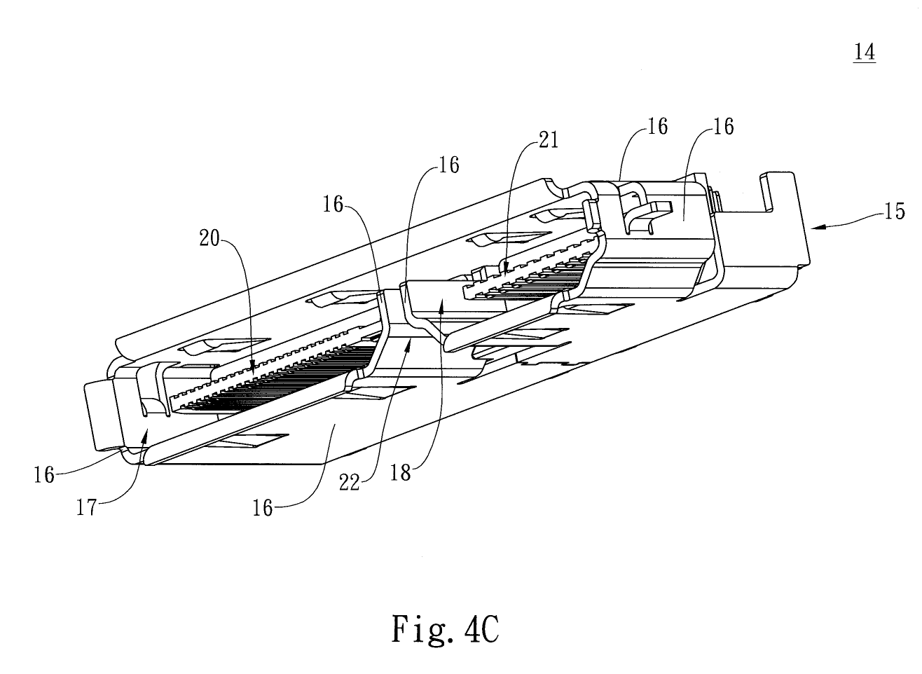

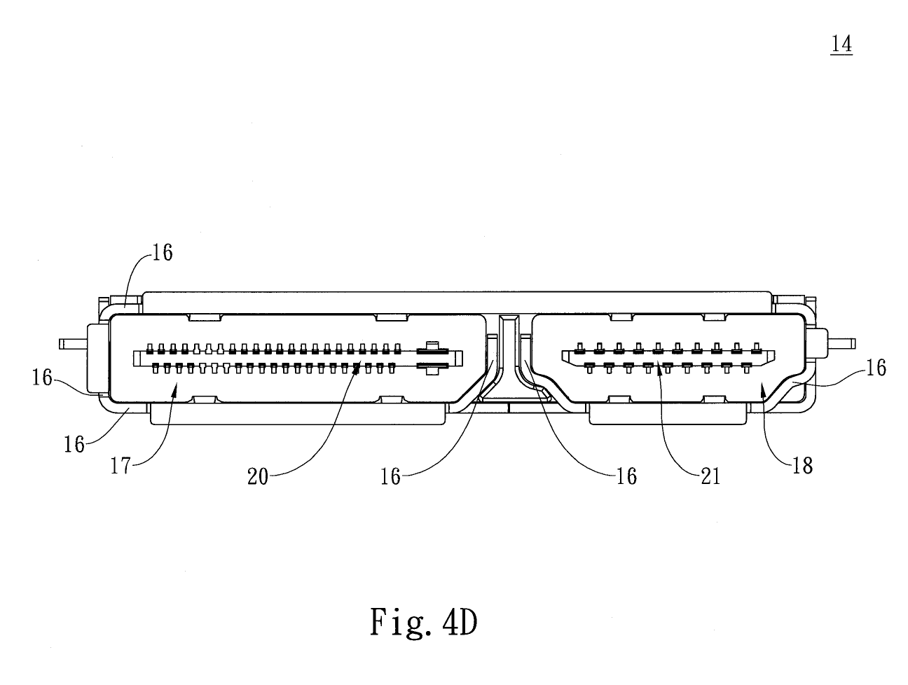

Referring to FIGS. 4A, 4B, 4C and 4D, another embodiment a socket connector 14 according to the invention is shown. In the embodiment shown, the socket connector 14 includes a shielding housing 15 having a plurality of sidewalls 16 that define a plurality of receiving slots 17 and 18, and a body 19 provided with two different types of I/O connectors—a first connector 20 and a second connector 21. The body 19 is assembled to the shielding housing 15 so that the first connector 20 is located within the receiving slot 17 and the second connector 21 is located within the receiving slot 18.

In the socket connector 14, the first connector 20 and the second connector 21 are arranged in a side-by-side manner, wherein the first connector 20 is a D-sub connector and the second connector 21 is an HDMI connector. Further, a space 22 is formed between the two receiving slots 17 and 18.

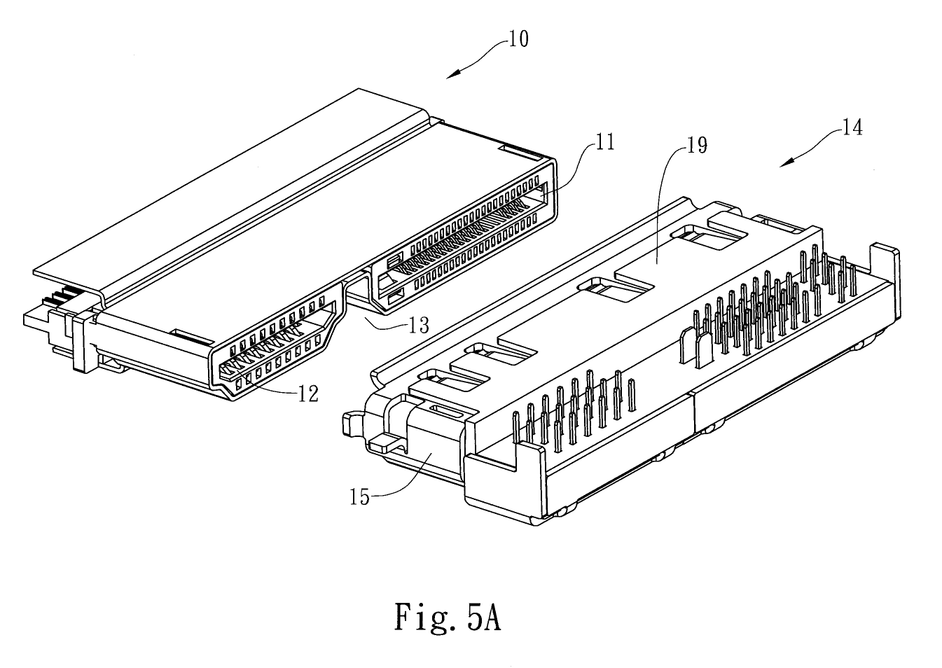

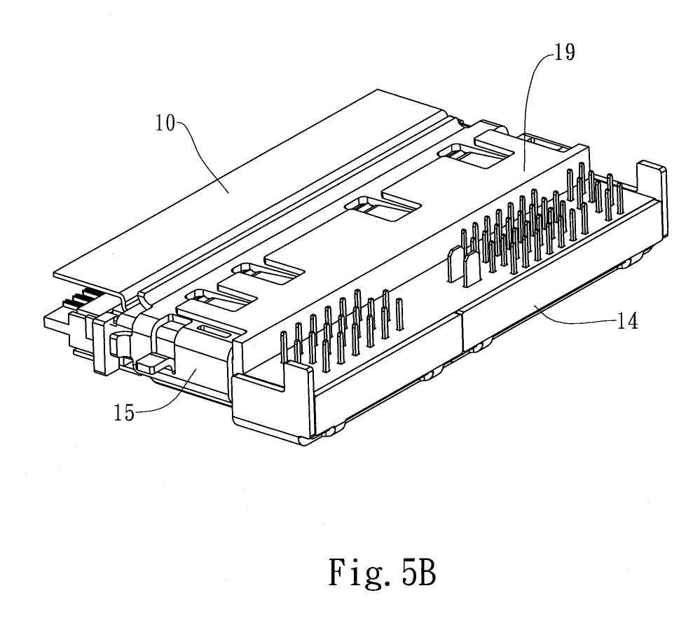

Referring to FIGS. 5A and 5B, the plug connector 10 and the socket connector 14 according to the alternate embodiment of the invention are shown. In the embodiment shown, the D-sub contact receptacle 11 and the HDMI contact receptacle 12 of the plug connector 10 match up with the D-sub connector 20 and the HDMI connector 21 of the socket connector 14 respectively.

When the plug connector 10 is inserted into the socket connector 14, the D-sub contact receptacle 11 is received in the receiving slot 17 to connect with the D-sub connector 20, and the HDMI contact receptacle 12 is received in the receiving slot 18 to connect with the HDMI connector 21.

The embodiments shown provide several advantages. For instance, the socket connector includes two different types of I/O connectors, including a D-sub connector and a high-speed transmission connector, such as a USB, eSATA, DisplayPort or HDMI connector. The plug connector may include a D-sub contact receptacle, one consisting of a high-speed transmission contact receptacle, or one consisting of both a D-sub contact receptacle and a high-speed transmission contact receptacle. In fact, the user may select one of the foregoing types of plug connectors depending on the socket connector that is used, and this will surely provide users greater convenience. Moreover, as the two I/O connectors of the socket connector are arranged side-by-side, users may optionally use one or both of them at a time. The arrangement helps minimize used space in the socket connector.

While this invention has been described by way of examples and in terms of preferred embodiments, it is to be understood that this invention is not limited hereto, and that various changes and modifications can be made by those skilled in the art without departing from the spirit and scope of this invention. It is intended that the scope of the invention be defined by the claims appended hereto.

What is claimed is:

1. A socket connector, comprising:
a shielding housing having a plurality of sidewalls defining a receiving slot; and
a body provided with a plurality of connectors, the body being assembled with the shielding housing such that the plurality of connectors are positioned within the receiving slot.

2. The socket connector according to claim 1, wherein the plurality of connectors includes a D-sub connector and an HDMI connector positioned side-by-side.

3. The socket connector according to claim 2, wherein the body further includes a guide between the plurality of connectors.

4. The socket connector according to claim 3, wherein the guide has a horizontal top edge and asymmetrical left and right edges.

5. The socket connector according to claim 3, further comprising a plug connector having a D-sub contact receptacle and an HDMI contact receptacle, the plug connector inserts into the socket connector.

6. The socket connector according to claim 5, wherein the plug connector further comprises a retaining portion between the D-sub contact receptacle and the HDMI contact receptacle for retaining the guide of the socket connector when the plug connector is inserted into the socket connector.

7. The socket connector according to claim 1, further comprising a plug connector having a D-sub contact receptacle, the plug connector inserts into the socket connector.

8. The socket connector according to claim 1, further comprising a plug connector having an HDMI contact receptacle, the plug connector inserts into the socket connector.

9. A socket connector, comprising:
a shielding housing having a plurality of sidewalls defining a plurality of receiving slots; and
a body provided with a plurality of connectors, the body assembles with the shielding housing so that the plurality of connectors are respectively located within the plurality of receiving slots.

10. The socket connector according to claim 9, further comprising a plug connector having a D-sub contact receptacle and an HDMI contact receptacle, the plug connector inserts into the socket connector.

11. The socket connector according to claim 9, further comprising a plug connector having a D-sub contact receptacle, the plug connector inserts into the socket connector.

12. The socket connector according to claim 9, further comprising a plug connector having an HDMI contact receptacle, the plug connector inserts into the socket connector.

13. The socket connector according to claim 9, wherein the plurality of receiving slots and the plurality of connectors are positioned side-by-side.

14. A socket connector, comprising:
a shielding housing having a plurality of sidewalls defining at least one receiving slot; and
a body provided with at least two different types of I/O connectors positioned side-by-side and a plurality of conductive contacts assembled to each of the at least two different types of I/O connectors;
wherein the shielding housing encloses a plurality of walls of the body so that the at least two different types of I/O connectors are located within the at least one receiving slot.

15. The socket connector according to claim 14, wherein the body has a D-sub connector.

16. The socket connector according to claim 14, wherein the body is provided has a high-speed transmission connector.

17. The socket connector according to claim 16, wherein the high-speed transmission connector is a USB, eSATA, DisplayPort or HDMI connector.

18. The socket connector according to claim 14, wherein the body includes a guide to facilitate a connection between the different types of I/O connectors and their corresponding plug connectors.

19. The socket connector according to claim 14, wherein the shielding housing includes a guide to facilitate the connection between the different types of I/O connectors and their corresponding plug connectors.

20. The socket connector according to claim 18, wherein the plug connector further includes contact receptacles which respectively correspond to the different types of I/O connectors.

21. The socket connector according to claim 19, wherein the plug connector further includes contact receptacles which respectively correspond to the different types of I/O connectors.

22. The socket connector according to claim 18, wherein the plug connector further includes a contact receptacle which corresponds to one of the different types of I/O connectors.

23. The socket connector according to claim 19, wherein the plug connector further includes a contact receptacle which corresponds to one of the different types of I/O connectors.
